(19) United States
(12) Patent Application Publication
(10) Pub. No.: US 2016/0068002 A1
(43) Pub. Date: Mar. 10, 2016

(54) HYBRID PRINT-ELECTRONIC BOOK

(71) Applicant: Todd Keller, Amityville, NY (US)

(72) Inventor: Todd Keller, Amityville, NY (US)

(21) Appl. No.: 14/837,175

(22) Filed: Aug. 27, 2015

Related U.S. Application Data
(60) Provisional application No. 62/046,711, filed on Sep. 5, 2014.

(51) Int. Cl. B42D 3/12; H04N 5/04; G11B 31/00; G11B 27/10

(52) U.S. Cl. CPC B42D 3/123; G11B 27/10; H04N 5/04; G11B 31/006

(57) ABSTRACT

The present invention is directed to a hybrid book. In one embodiment, the hybrid book includes a plurality of pages containing a plurality of fixed media, a data controller, digital storage, an electronic visual display, a display driver and a power source. The hybrid book is configured and adapted to receive visual media into the digital storage for playback on the electronic visual display. The power source may optionally be a battery and preferably a rechargeable battery. The hybrid book presents the plurality of fixed media and the visual media in combination. The data controller, digital storage, electronic visual display and display driver are preferably communicatively coupled together. The digital storage preferably is programmable, but not re-writeable or re-programmable. In other embodiments, the digital storage may be re-writeable or re-programmable. The pages may be fixed by a spine. The hybrid book may include a cover, and the electronic visual display may be attached to the cover. The hybrid book may be configured and adapted to present the plurality of fixed media simultaneously with the visual media. The hybrid book may include a plurality of input and/or output ports. A port may be included for a power source to recharge the battery or to connect an external power supply. Another port may be used to load electronic media into the digital storage.

### RELATED APPLICATIONS

This application claims the benefit of, and priority to, U.S. Provisional Application No. 62/046,711, filed on Sep. 5, 2014, entitled “Hybrid Print-Electronic Book,” which is incorporated herein by reference in its entirety.

### FIELD OF THE INVENTION

The present invention relates to books, pamphlets and the like and, in particular, to a hybrid book that has both fixed content on physical pages and an electronic display.

### BACKGROUND OF THE INVENTION

With the advent of hand-held computing devices, modern consumer electronic devices forgo physical pages with fixed content in favor of electronic displays which can display text and/or illustrations that can be modified, changed and altered, including the ability to show video. It is an object of the invention to retain the familiarity and accessibility of fixed content on physical pages while providing an integrated electronic multimedia experience.

Ubiquitous modern devices such as smart phones, tablets, readers (KINDLE®, NOOK®, etc.), video games and the like present media using an electronic visual display, leaving the traditional concept of physical pages to traditional books. In such modern devices, physical pages appear to add little, if anything, to a user's visual experience. Pages may even hinder usability by adding weight and by demanding additional care to prevent the wear and tear of fragile pages. It is therefore an object of the invention to enhance the multimedia experience available through fixed media or electronic media alone.

### SUMMARY OF THE INVENTION

The present invention is directed to a hybrid book. In one embodiment, the hybrid book includes a plurality of pages containing a plurality of fixed media, a data controller, digital storage, an electronic visual display, a display driver and a power source. The hybrid book is configured and adapted to receive visual media into the digital storage for playback on the electronic visual display. The power source may optionally be a battery and preferably a rechargeable battery. The hybrid book presents the plurality of fixed media and the visual media in combination. The data controller, digital storage, electronic visual display and display driver are preferably communicatively coupled together. The digital storage preferably is programmable, but not re-writeable or re-programmable. In other embodiments, the digital storage may be re-writeable or re-programmable. The pages may be fixed by a spine. The hybrid book may include a cover, and the electronic visual display may be attached to the cover. The hybrid book may be configured and adapted to present the plurality of fixed media simultaneously with the visual media. The visual media may be streamed by temporarily storing a portion of a video file in the digital storage. The hybrid book may include a plurality of input and/or output ports. A port may be included for a power source to recharge the battery or to connect an external power supply. Another port may be used to load electronic media into the digital storage.

In another embodiment, the hybrid book includes a plurality of physical pages containing a plurality of fixed media, a cover, a data controller, digital storage, an electronic visual display, a display driver, an input interface, a speaker and a battery. The plurality of pages are fixed together by a spine. The digital storage is communicatively coupled to the data controller. The electronic visual display is communicatively coupled to the data controller for displaying a video file, and is attached to the cover. The display driver preferably is communicatively coupled to the data controller and to the electronic visual display. The input interface is communicatively coupled to the digital storage for loading the video file and the audio file into the digital storage. The speaker is communicatively coupled to the data controller for playing an audio file. The hybrid book is configured and adapted to receive the video file into the digital storage for future playback on the electronic visual display. The hybrid book is configured and adapted to receive the audio file into the digital storage for future playback through the speaker. The cover may either completely or partially overly and protect the plurality of physical pages that include the plurality of fixed media. The hybrid book presents the plurality of fixed media in combination with the video file and the audio file. The digital storage is preferably programmable, but not re-writeable or re-programmable. In other embodiments, the digital storage may be re-writeable or re-programmable. The hybrid book may include a microphone communicatively coupled to the data controller. In that case, the hybrid book may be configured and adapted to receive an audio signal from the microphone and configured to store the audio signal into the digital storage for playback through the speaker. The hybrid book may present the plurality of fixed media in combination with the audio signal. The hybrid book may be configured and adapted to present the fixed media simultaneously with the video file and the audio file. The input interface may include an input port. The battery may be rechargeable through and by use of the input port. The plurality of fixed media may include photographs. The video file and the audio file may be a single file. The single file may be streamed by temporarily storing a portion of the single file in the digital storage.

In another embodiment, the hybrid book includes a plurality of physical pages containing a plurality of fixed media, a cover overlying and protecting the plurality of physical pages that include the plurality of fixed media, a data controller, digital storage, an electronic visual display, a display driver, an input interface, a speaker and a battery. The plurality of pages are fixed together by a spine. The digital storage is communicatively coupled to the data controller. The electronic visual display is communicatively coupled to the data controller for displaying a video file, and is attached to the cover. The display driver is communicatively coupled to the data controller and to the electronic visual display. The input interface is communicatively coupled to the digital storage for loading the video file and the audio file into the digital storage. The speaker is communicatively coupled to the data controller for playing an audio file. The digital storage contains the video file for future playback on the electronic visual display and the audio file for future playback through the speaker. The video file and/or the audio file may be stored into digital storage by the book manufacturer or by the customer or end user for later presentation in combination with the plurality of fixed media.

### BRIEF DESCRIPTION OF THE DRAWINGS

The various aspects and embodiments disclosed herein will be better understood when read in conjunction with the drawings provided. Preferred embodiments are provided in the drawings for the purposes of illustrating aspects, features and/or embodiments of the hybrid book. It should be understood, however, that the invention is not limited to the precise arrangement, structures, features, embodiments, aspects and devices shown, and the arrangements, structures, features, embodiments, aspects and devices shown may be used singularly or in combination with other arrangements, structures, features, embodiments, aspects and devices. The drawings are not necessarily to scale and are not in any way intended to limit the scope of this invention, but are merely presented to illustrate and describe various preferred embodiments of the invention.

FIG. 1 illustrates the layout of a hybrid book with fixed media on physical pages and an electronic visual display in accordance with one embodiment of the invention;

FIG. 2 illustrates an arrangement of electronics on or in a hybrid book cover in accordance with an embodiment of the invention;

FIG. 3 illustrates a hybrid book layout with fixed media on physical pages and an electronic visual display in accordance with another embodiment of the invention.

### DETAILED DESCRIPTION OF THE PREFERRED EMBODIMENTS

In the following detailed description, numerous details are set forth in order to provide an understanding of the hybrid book. However, it will be understood by those skilled in the art that the invention may be practiced without these specific details and should not be limited to the embodiments or the specified features or details shown. In circumstances, well-known methods, procedures, components and circuits have not been described in detail so as not to obscure the invention. In the drawings and description, identical reference numerals indicate those components that are common to different embodiments or configurations.

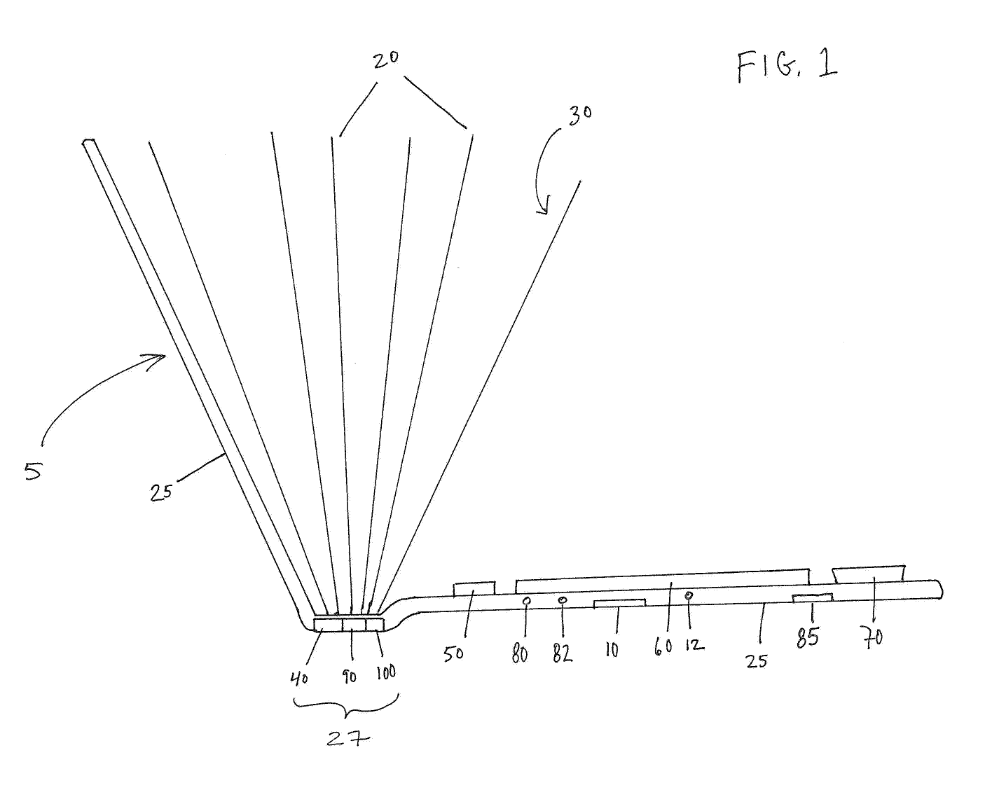

As illustrated in FIG. 1, in accordance with certain embodiments, the hybrid book 5 comprises physical pages 20 with fixed media 30, a power source 10, a data controller 40 communicatively coupled to digital storage 100, a display driver 90, an electronic visual display 60 and optionally a microphone 50, a speaker 70 and input and output ports 80. The hybrid book 5 is configured and adapted to present fixed media 30 and electronic media. Electronic media generally includes visual media such as video files and/or audible media such as audio files. The visual media may include any type of visual information capable of playback through the electronic visual display 60 such as text and/or images, whether moving or stationary. The audible media may include any type of audible information capable of playback through the speaker 70 such as voice recordings, sounds or music.

The physical pages 20 are generally paper stock, cardboard or other substrate suitable for displaying the fixed media 30. The physical pages 20 may be arranged in any orientation, for example as a fold-out book, but preferably are separate sheets fixed by a spine 27. The fixed media 30 may include text and/or illustrations permanently fixed on the physical pages 20, for example with the use of letterpress, offset printing, flexography, gravure, screen printing, digital printing, laser printing or otherwise. The fixed media 30 is not programmable.

The data controller 40 is generally one or more components that perform basic arithmetical, logical and input/output operations of the system. For example, the data controller 40 executes user commands, provides control signals to system components and otherwise controls the electronics. The data controller 40 is communicatively coupled to the various electronic components of the hybrid book 5, including the digital storage 100, the display driver 90 and the electronic visual display 60. The data controller 40 generally detects the user commands and sends control signals to the various electronic components, for example the electronic visual display 60, display driver 90 and/or digital storage 100, that execute the command. In one example, the data controller 40 (or control electronics communicatively coupled to the data controller 40) retrieves pre-loaded electronic media residing in the digital storage 100, and controls the various components, e.g. the display driver 90, to play the electronic media on the electronic visual display 60 and/or the speaker 70. For example, the data controller 40 may send control signals to the display driver 90 so that the electronic media is processed by the display driver 90, and to the electronic visual display 60 so that the processed electronic media is displayed on the electronic visual display 60. In practice, a person of ordinary skill in the art may include additional functionality such as ensuring that power is provided to the electronic components before executing. Alternately, a person of ordinary skill in the art may consolidate the logic, for example, by connecting the same command line to multiple components. Some functionality of the data controller 40 may be delegated to other components, or other components may be packaged together (i.e., the data controller 40, the display driver 90 and/or the electronic visual display 60). The combined electronics may require a single command to operate. Command circuits and command logic are well-known and can be implemented by those skilled in the art. In practice, the data controller 40 is usually a silicon chip such as an integrated circuit, for example, an ASIC chip, but may be composed of a number of integrated circuits or component parts.

The data controller 40 is communicatively coupled to digital storage 100. Digital storage 100 is generally a component or group of components that store data, for example, electronically, optically, magnetically or mechanically, alone or in combination. Electronic media is stored in the digital storage 100. In some embodiments, the digital storage 100 is partially or entirely incorporated in the data controller 40. The digital storage 100 may be non-volatile or volatile. Examples of digital storage include various types of random access memory (RAM), read-only memory, flash memory, ferroelectric RAM, hard disks, floppy disks, magnetic tape, optical disks, holographic memory, and the like. The digital storage 100, however, is not limited to these examples, and other types of digital storage are contemplated. The digital storage 100 is preferably programmable. The digital storage 100 is preferably programmable and preferably programmable by the intended consumer or user. The digital storage 100 may be re-programmable, and the visual media that may be presented on the electronic visual display 60 also may be capable of modification. For example, the digital storage 100 is preferably writable, but may also be erasable and re-writable. However, in some embodiments, the digital storage 100 may only be initially writable and not erasable or re-writable. The electronic media stored in the digital storage 100 may include visual media, and preferably a video file or files. The electronic media stored in the digital storage 100 may also include audible media. The audible media may be incorporated into the same file or files as the visual media. For example, a video file may contain both audible and visual components. Alternately, a video file may only contain visual components, and the audible media may comprise one or more separate audio files for use alone or in combination with the visual media.

In an alternative embodiment, instead of loading electronic media into digital storage for later playback, the hybrid book 5 may comprise wireless circuits 85 to stream remotely stored media. In this example, the hybrid book 5 would include an input interface with remote capabilities such as a wireless interface, which is well-known and may be implemented by a person of ordinary skill in the wireless communications art. To stream the electronic media, the hybrid book 5 may download the electronic media using a remote connection and may temporarily store the electronic media, or portions thereof, in the digital storage 100 for immediate playback. The streaming process is also well-known and may be implemented by a person of ordinary skill.

The data controller 40 is also communicatively coupled to one or more display drivers 90, which are communicatively coupled to one or more electronic visual displays 60. The display driver 90 is generally one or more components that generate a visual signal or signals from the electronic media for display on the electronic visual display 60. The display driver 90 is generally a silicon chip such as an integrated circuit, and may be an ASIC. For example, the display driver 90 may be a video processor, video controller or video driver. The display driver 90 could be integrated into the data controller 40. Alternately, the display driver 90 could be separate and could manipulate the electronic media independently of the data controller 40. The display driver 90 could also be integrated into the electronic visual display 60. Some or all of the digital storage 100 may be incorporated into the display driver 90. The display driver 90 may also generate an audio signal. Display drivers are well-known and may be implemented by those skilled in the art.

The data controller 40 is also communicatively coupled to one or more electronic visual displays 60. Preferably, the electronic visual display 60 is a flexible LCD, but may be LED, combination LCD/LED, OLED, plasma, electrochromatic or rigid LCD display. The data controller 40 controls the presentation of the visual media on the electronic visual display 60. Electronic visual displays are well-known and may be implemented by those skilled in the art.

The hybrid book 5 may also include one or more speakers 70 communicatively coupled to the data controller 40. The hybrid book 5 with speakers 70 may contain one or more amplifiers or audio drivers. The data controller 40 controls the presentation of the audible media through speaker(s) 70. In some embodiments, the hybrid book 5 includes a microphone 50 communicatively coupled to the data controller 40. The microphone 50 can be used to record audible media to be stored in the digital storage 100 and presented through the speaker 70. Audio circuitry, amplifiers and audio drivers are well-known and can be implemented by those skilled in the art.

The hybrid book 5 may also include an input interface with one or more input ports 80. An input port 80 may be used to program or load audible or visual media into the digital storage 100. Alternately, the input port 80 may be used to route audible or visual media to the electronic visual display 60 and/or the speaker 70, bypassing the digital storage 100. The hybrid book 5 may include one or more output ports 82 that may be communicatively coupled to the data controller 40 and/or the digital storage 100. An output port 82 may be used to route audible or visual media to external devices such as an external monitor or an external speaker.

Power source 10 provides power to the electronics and may be, for example, a battery or a solar cell. Alternatively, a power input port 12 may be provided to connect an external power source. Power source 10 is coupled to the data controller 40, the digital storage 100, the electronic visual display 60, the display driver 90, the audio circuits for the speaker 70 and microphone 50. For example, the hybrid book 5 may include a rechargeable lithium battery and a power input port 12 for a plug-in adapter to charge the battery. The power input port 12 may be the same port as input port 80, for example, a mini USB port, but could be a separate dedicated power input port.

The hybrid book 5 may include an on/off function. For example, the power source may be disconnected from the electronics via a switch. In other embodiments, the switch is automatically triggered to play the electronic media by, for example, when the hybrid book 5 is opened, and the trigger or sensor may be mechanical, optical, magnetic or otherwise.

The hybrid book 5 optionally includes covers 25, which may be hard stock or flexible. The covers 25 may wholly or partially overlie or surround the physical pages 20 and may protect the physical pages 20 from wear and tear and the environment. As illustrated in the embodiment of FIGS. 1 and 2, the electronic visual display 60, speaker 70 and microphone 50 may be integrated into or on one of the covers 25, and the data controller 40 may be integrated into the spine 27. Of course, other configurations are possible. For example, the data controller 40 may be integrated into one of the covers 25 rather than the spine 27. In FIGS. 1 and 2, the electronic visual display 60 is illustrated on the inside center portion of one of the covers 25, however, the electronic visual display 60 may be arranged in different locations on the covers 25, front or back, inside or outside. The electronic visual display 60 may also be a different size or a different shape and may be associated with or connected to the physical pages 20, instead or in addition to the cover 25.

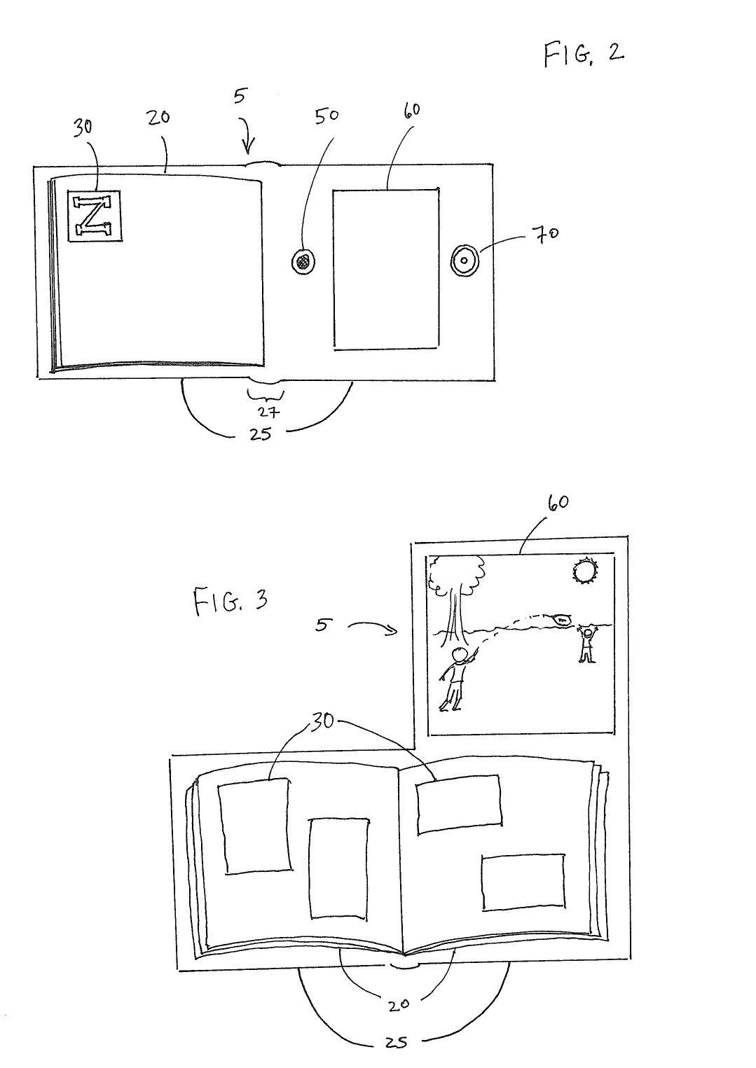

In certain embodiments, the physical pages 20 may be configured so that the electronic visual display 60, one or more of the physical pages 20 and/or one or more of the covers 25 are visible simultaneously. For example, as illustrated in the embodiment of FIG. 3, when the hybrid book 5 is open and lying on a flat surface, the electronic visual display 60 is located above the physical pages 20. Alternately, the electronic visual display 60 may be located below or to the side of the physical pages 20. The electronic visual display 60 may be located on the inside of the back cover, and holes may be formed in the physical pages 20 so that the electronic visual display 60 is viewable by a user in combination with multiple physical pages 20.

There could also be more than one electronic visual display. For example, in certain embodiments, electronic visual displays may be integrated into one or more physical pages such that both fixed media and visual electronic media are combined on a single page. This would permit the presentation of pictures and video side-by-side.

In a preferred embodiment, the hybrid book is a photo book from, for example, a family vacation that comprises photographs fixed on physical pages, a battery, a data controller, a display driver, digital storage, an electronic visual display, a speaker and input ports. Preferably, the user inputs a video from a vacation or similar event into the digital storage for purposes of memorializing and remembering the event. Alternately, the book provider may load the video into the digital storage. The video once programmed is preferably not erasable or capable of re-programming. Alternately, the user may stream electronic media from a remote location. The hybrid book combines the photographs and other fixed media on the physical pages and covers with a short video from the vacation, creating a nostalgic experience that can be revisited years later. The user may also record personalized audible media to accompany the video. Preferably the audible media is programmed by the user but is not erasable or capable of re-programming. Alternately, the book provider may load the audible media into digital storage, or the user may stream the audible media from a remote location. The result is an easy-to-use family photo book that incorporates still photos and preferably personalized visual and audible media. The hybrid photo book combines fixed media content such as still photographs with programmable electronic media to create an enhanced multimedia experience. A picture book, for example, for display on a coffee table, is enhanced with the addition of accompanying visual and audible media.

In one sample implementation, the data controller, display driver, audio circuitry and parts of the digital storage may be implemented using two chipsets, Allwinner E200 and Actions Semiconductor ATM7039. The digital storage may be implemented with Hynix NAND Flash model HY27UF082G2B and Hynix DDR-SDRAM model HY5DU561622DT. Using these components and the disclosure herein, the hybrid book may be implemented by a person of ordinary skill in the art.

Those skilled in the art will recognize that the invention has many applications, may be implemented in various manners and, as such is not to be limited by the foregoing embodiments and examples. Any number of the features of the different embodiments described herein may be combined into a single embodiment. The locations of particular elements may be altered. Alternate embodiments are possible that have additional features than those described or may have less than all the features described. Functionality may also be, in whole or in part, distributed among multiple components, in manners now known or to become known.

It will be appreciated by those skilled in the art that changes could be made to the embodiments described above without departing from the broad inventive concept. It is understood, therefore, that this invention is not limited to the particular embodiments disclosed, but it is intended to cover modifications within the spirit and scope of the invention. While fundamental features of the invention have been shown and described in exemplary embodiments, it will be understood that omissions, substitutions and changes in the form and details of the disclosed invention may be made by those skilled in the art without departing from the spirit of the invention. Moreover, the scope of the invention covers conventionally known, future developed variations and modifications to the components described herein as would be understood by those skilled in the art.

To avoid any ambiguity in the scope of protection sought, terms and phrases which are not explicitly defined should be given their broadest reasonable interpretation. As used herein, the singular forms “a”, “an” and “the” may be intended to include the plural forms as well, unless the context clearly indicates otherwise. It is intended that the scope of the invention not be limited by the examples described but rather be defined by the claims appended hereto and their equivalents.

1. A hybrid book comprising:
a plurality of pages containing a plurality of fixed media;
a data controller;
programmable digital storage communicatively coupled to the data controller;
an electronic visual display communicatively coupled to the data controller;
a display driver communicatively coupled to the data controller and to the electronic visual display; and
a power source,
wherein the hybrid book is configured and adapted to receive visual media into the digital storage for playback on the electronic visual display in order to present the plurality of fixed media and the visual media in combination.

2. The hybrid book of claim 1 wherein the digital storage is programmable but not re-writeable.

3. The hybrid book of claim 1 further comprising a cover, wherein the electronic visual display is attached to the cover.

4. The hybrid book of claim 1 wherein the hybrid book is configured and adapted to present the plurality of fixed media simultaneously with the visual media.

5. The hybrid book of claim 1 wherein the visual media is streamed by temporarily storing a portion of a video file in the digital storage.

6. A hybrid book comprising:
a plurality of physical pages containing a plurality of fixed media, the plurality of pages fixed together by a spine;
a cover at least partially overlying and protecting the plurality of physical pages that include the plurality of fixed media;
a data controller;
programmable digital storage communicatively coupled to the data controller;
an electronic visual display communicatively coupled to the data controller for displaying a video file, the electronic visual display attached to the cover;
a display driver communicatively coupled to the data controller and to the electronic visual display;
an input interface communicatively coupled to the digital storage for loading the video file and the audio file into the digital storage;
a speaker communicatively coupled to the data controller for playing an audio file; and
a battery,
wherein the hybrid book is configured and adapted to receive the video file into the digital storage for future playback on the electronic visual display and to receive the audio file into the digital storage for future playback through the speaker in order to present the plurality of fixed media with the video file and the audio file in combination.

7. The hybrid book of claim 6 wherein the digital storage is programmable but not re-writeable.

8. The hybrid book of claim 6 further comprising a microphone communicatively coupled to the data controller, wherein the hybrid book is configured and adapted to receive an audio signal from the microphone into the digital storage for playback through the speaker in order to present the plurality of fixed media with the audio signal in combination.

9. The hybrid book of claim 6 wherein the hybrid book is configured and adapted to present the fixed media simultaneously with the video file and the audio file.

10. The hybrid book of claim 6 wherein the input interface includes an input port.

11. The hybrid book of claim 6 wherein the battery is rechargeable.

12. The hybrid book of claim 6 wherein the plurality of fixed media includes photographs.

13. The hybrid book of claim 6 wherein the video file and the audio file are a single file.

14. The hybrid book of claim 13 wherein the single file is streamed by temporarily storing a portion of the single file in the digital storage.

15. A hybrid book having a plurality of physical pages with a plurality of fixed media and a cover, wherein the improvement comprises:
a data controller;
programmable digital storage communicatively coupled to the data controller;
an electronic visual display communicatively coupled to the data controller;
a display driver communicatively coupled to the data controller and to the electronic visual display;
a speaker communicatively coupled to the data controller; and
a power source,
wherein the hybrid book is configured and adapted to receive a video file into the digital storage for playback on the electronic visual display and to receive an audio file into the digital storage for playback through the speaker, in order to present the plurality of fixed media with the video file and the audio file in combination.

16. The hybrid book of claim 15 further comprising a cover, wherein the electronic visual display is attached to the cover.

17. The hybrid book of claim 15 wherein the video file and the audio file are a single file.

18. The hybrid book of claim 17 wherein the single file is streamed by temporarily storing a portion of the single file in the digital storage.

19. A hybrid book comprising:
a plurality of physical pages containing a plurality of fixed media, the plurality of pages fixed together by a spine;
a cover overlying and protecting the plurality of physical pages that include the plurality of fixed media;
a data controller;
digital storage communicatively coupled to the data controller, digital storage containing a video file and an audio file;
an electronic visual display communicatively coupled to the data controller for displaying a video file, the electronic visual display attached to the cover;
a display driver communicatively coupled to the data controller and to the electronic visual display;
an input interface communicatively coupled to the digital storage for loading the video file and the audio file into the digital storage;
a speaker communicatively coupled to the data controller for playing an audio file; and
a battery,
wherein the digital storage contains the video file for future playback on the electronic visual display and the audio file for future playback through the speaker, for presentation in combination with the plurality of fixed media.
